(19) United States
(12) Patent Application Publication
(10) Pub. No.: US 2019/0036479 A1
(43) Pub. Date: Jan. 31, 2019

(54) SOLAR ARRAY MODULE CONFIGURED TO EXPLOIT BERNOULLI'S FORCES

(71) Applicant: BEIJING APOLLO DING RONG SOLAR TECHNOLOGY CO., LTD., Beijing (CN)

(72) Inventor: Geordie ZAPALAC, Santa Clara, CA (US)

(21) Appl. No.: 15/660,086

(22) Filed: Jul. 26, 2017

(51) Int. Cl. H02S 30/00; H02S 20/23

(52) U.S. Cl. CPC H02S 30/00; H02S 20/23

(57) ABSTRACT

Various embodiments include a solar panel having a bottom surface adjacent to the base layer having a curved shape configured to generate a downward force when subject to wind. The bottom surface may be an outer surface of the base layer that has a convex shape. The bottom surface may be integral to the base layer and have a convex shape. The bottom surface may be a shell coupled to the base layer with an outer surface that has a convex shape. Such a shell may form a void space between the shell and the base layer. By exhibiting a convex shape, the bottom surface may generate a downward force in wind due to Bernoulli's Principle that helps to resist wind forces that would otherwise tear the panel from its mountings.

### FIELD

The present disclosure is directed to solar panels in general and to protecting solar installations from damage in high winds in particular.

### BACKGROUND

Extremely high winds are often the greatest hazard faced by solar installations in the field, especially for installations in some coastal regions such as the southeastern United States. Rooftop installation of currently available commercial photovoltaic systems often use a solar panel rack or other mounting structure that hold the solar panel at an angle to more directly face the sun, thereby increasing the amount of solar flux received by the panel. The angle at which the solar panel is mounted differs depending upon, for example, the pitch of a building's roof and the latitude of the installation. Thus, conventional rooftop solar panels are typically mounted with one end of the panel higher than the other end. This mounting configuration of the solar panel may further worsen drag forces during extremely high winds that may tear the solar panel from its mounting structure.

### SUMMARY

Various embodiments include a solar panel having a receiving layer oriented to receive sunlight, a photovoltaic layer adjacent to the receiving layer, a base layer adjacent to the photovoltaic layer, and a bottom surface adjacent to the base layer having a curved shape configured to generate a downward force when subject to wind. The bottom surface may be an outer surface of the base layer that has a convex shape. The bottom surface may be integral to the base layer and have a convex shape. The bottom surface may be a shell coupled to the base layer with an outer surface that has a convex shape. Such a shell may form a void space between the shell and the base layer. By exhibiting a convex shape, the bottom surface may generate a downward force in wind due to Bernoulli's Principle that helps to offset drag forces from wind that would otherwise tear the panel from its mountings.

### BRIEF DESCRIPTION OF THE DRAWINGS

FIG. 1 is a vertical cross-sectional view of a photovoltaic panel according to the prior art.

FIG. 2 is a vertical cross-sectional view of a photovoltaic panel configured with a curvature according to some embodiments.

FIG. 3 is a vertical cross-sectional view of a photovoltaic panel that has planar layers and a solid curve shell under-carriage according to another embodiment.

FIG. 4 is a vertical cross-sectional view of a photovoltaic panel that has planar layers and a hollow curve shell under-carriage according to another embodiment.

FIG. 5 is a perspective view of the curve shell underneath a photovoltaic panel as represented by a bi-quadratic equation according to an embodiment.

FIG. 6 is a perspective view of a photovoltaic panel mounted to a building structure according to another embodiment.

FIG. 7 is a schematic diagram of the curvature of the photovoltaic panel above a roof surface and the relative wind over the panel illustrated in FIG. 2.

### DETAILED DESCRIPTION

The drawings are not drawn to scale. Multiple instances of an element may be duplicated where a single instance of the element is illustrated, unless absence of duplication of elements is expressly described or clearly indicated otherwise. Ordinals such as “first,” “second,” and “third” are employed merely to identify similar elements, and different ordinals may be employed across the specification and the claims of the instant disclosure. As used herein, a first element located “on” a second element can be located on the exterior side of a surface of the second element or on the interior side of the second element. As used herein, a first element is located “directly on” a second element if there exist a direct physical contact between a surface of the first element and a surface of the second element. As used herein, an element is “configured” to perform a function if the structural components of the element are inherently capable of performing the function due to the physical and/or electrical characteristics thereof.

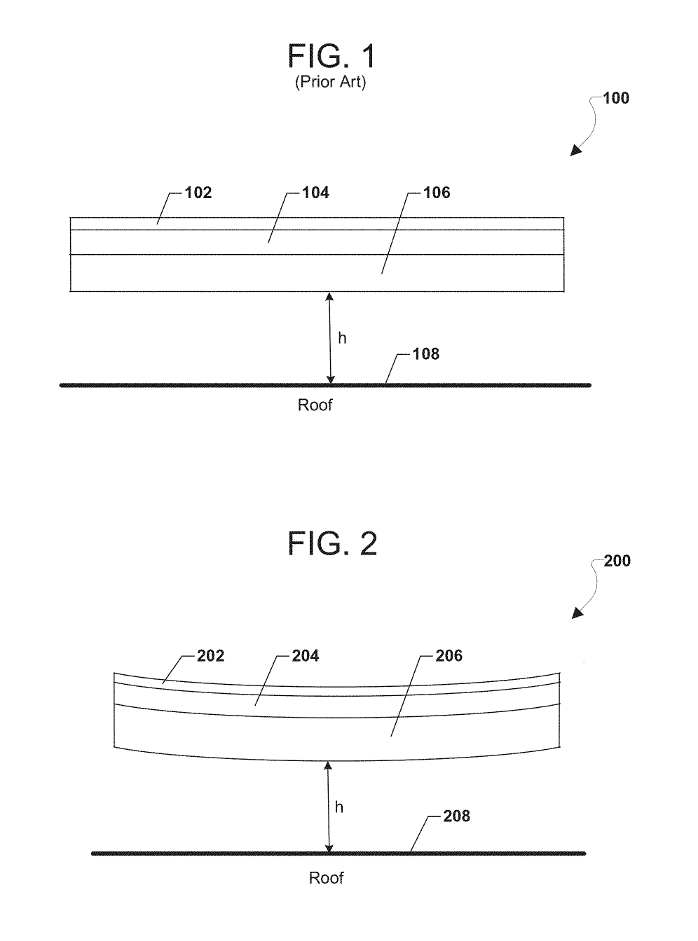

Referring to FIG. 1, a vertical cross-sectional view of a conventional photovoltaic panel 100 is illustrated. The panel 100 may include three rigid planar layers; a receiving layer 102, a photovoltaic cell layer 104, and a base layer 106. The receiving layer 102 receives sunlight through a transparent surface so that the adjoining photovoltaic cell layer 104 can convert the sunlight into electrical energy. The base layer 106 may be a substrate of sorts providing support to all layers of the panel 100. The number of layers may vary from one photovoltaic panel to another and the description herein is provided for simplicity of explanation.

The panel 100 may be mounted on a building structure (e.g., a roof) or another structure where there is unobstructed exposure to sunlight. In FIG. 1, the panel 100 is shown with the panel elevated above the roof 108 at height (h). Whether on a flat or sloped roof, the panel 100 can cause wind loads. That is, as wind travels parallel to the roof passing above and below the planar panel 100, the panel 100 may cause a drag force that may tear the panel 100 from its mountings (not shown). The panel 100 also may be angled toward the sun to increase the angle of incidence and thus the amount of solar flux received by the panel.

FIG. 2 illustrates an improved photovoltaic panel 200 according to some embodiments that reduces the potential for damage by high winds. The panel 200 may also include three flexible layers; a receiving layer 202, a photovoltaic cell layer 204, and a base layer 206. The numbers of layers are simplified for explanation purposes. The panel 200 may be positioned a height (h) above a roof 208.

The panel 200 in FIG. 2 may be formed with a curvature having a concave shape with respect to an outer surface of receiving layer 202 and a convex shape with respect to an outer surface of the base layer 206. The curvature of panel 200 may form an airfoil that generates a downward force as air flows over the panel. Such a downward force may act to resist wind loads that act to lift the panel from the roof 208. Any component of wind parallel to the roof 208 will increase the velocity underneath the panel as the cross-sectional area between the panel 200 and the roof 208 decreases, reducing the pressure beneath the panel 200 by Bernoulli's principle. The reduction of pressure beneath the panel 200 exerts a downward force on the panel 200 toward the roof 208. The downward force helps to stabilize the panel 200 against the drag force caused by a vertical component of wind's velocity that pushes the panel 200 away from the roof 208. The magnitude of the downward force will depend on the curvature of the panel 200 and the wind speed, while the magnitude of the drag force is dependent on a deflection angle of the wind at the leading edge of the panel 200.

The curvature of the photovoltaic panel 200 may be symmetric about the longitudinal and lateral axes. Alternatively, the curvature may be independently symmetric about the longer longitudinal axis and the shorter lateral axis. The panel 200 may have an arbitrary outer perimeter shape.

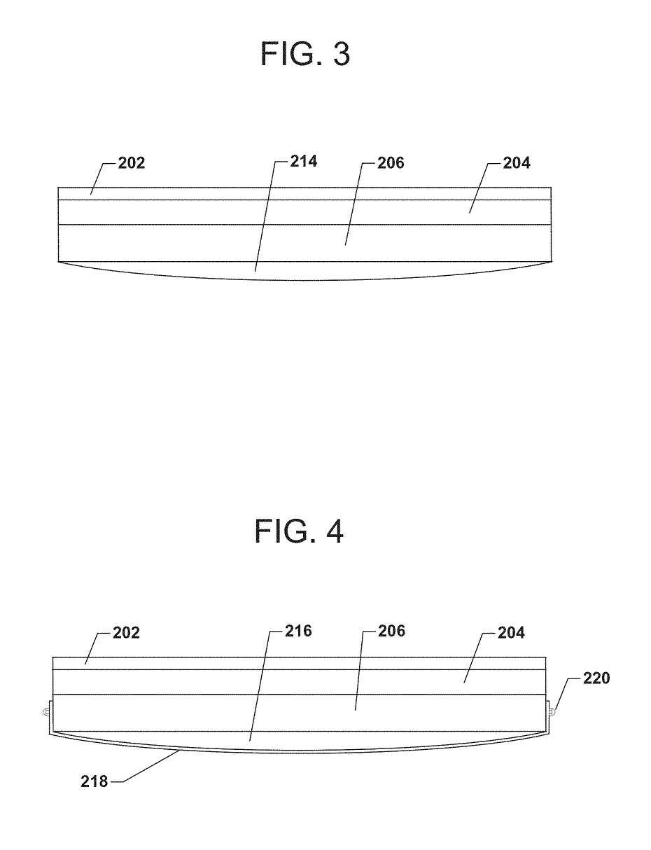

FIG. 3 illustrates a vertical cross-sectional view of a photovoltaic panel 200 with three rigid planar layers including a receiving layer 202, a photovoltaic cell layer 204, and a base layer 206 like that in FIG. 1. The panel 200 may also include a solid curved shell 214 that is integral to the base layer 206, in that the curved shell is manufactured together with the base layer 206. The integral solid curved shell 214 may be a material with a curved lower surface made of molded plastic or any other type of material. The solid curved shell 214 may be shaped to form an airfoil to generate downward force when exposed to wind as described above for the panel 200 with a curve shape. Thus, the integral solid curved shell 214 of panel 200 may be configured to resist wind loads at the roof 208 because any component of wind velocity parallel to the roof 208 will increase underneath the panel as the cross-sectional area between the panel 200 and the roof 208 decreases, reducing the pressure beneath the panel 200 by Bernoulli's principle. The reduction of pressure causes a downward force to be exerted on the panel 200 towards a mounting surface.

FIG. 4 illustrates a vertical cross-sectional view of a photovoltaic panel 200 that has three rigid planar layers including a receiving layer 202, a photovoltaic cell layer 204, and a base layer 206 like that in FIG. 1. However, the panel 200 in FIG. 4 may also include a hollow curve shell 218 that is fastened to the base layer 206 by fasteners 220. The fasteners 220 may be any of various types of bolts, nuts, screws, welding, or other fasteners. The hollow curve shell 218 may be a curved sheet of material with a curved lower surface made of molded plastic or any other type of material. The hollow curve shell 218 may define a void space 216 located in between the base layer 206 and the fastened hollow curve shell 218. The hollow curve shell 218 may provide advantages through weight reduction and easier post manufacture assembly/disassembly of the hollow curve shell 218 from the base layer 206. Like the solid curve shell 214, the hollow curve shell 218 induces a low pressure area beneath the panel 200 during windy conditions causing a downward force to be exerted on the panel 200 toward the mounting surface by Bernoulli's Principle.

The shape of the solid curved shell 214 and the hollow curved shell 218 beneath the rigid planar layers shown in FIGS. 3 and 4 may be determined by the following bi-quadratic surface equation, where x₀ and y₀ are half widths of a rectangular panel, Δ=the depth of the shell at the center of the shell (x=y=0), and Δ−z(x, y) is the depth of the shell at a position x, y, where:

$$z ( x , y ) = Δ [ 1 - \frac{{( x - {x}_{0} )}^{2} {( y - {y}_{0} )}^{2}}{{x}_{0}^{2} {y}_{0}^{2}} ]$$

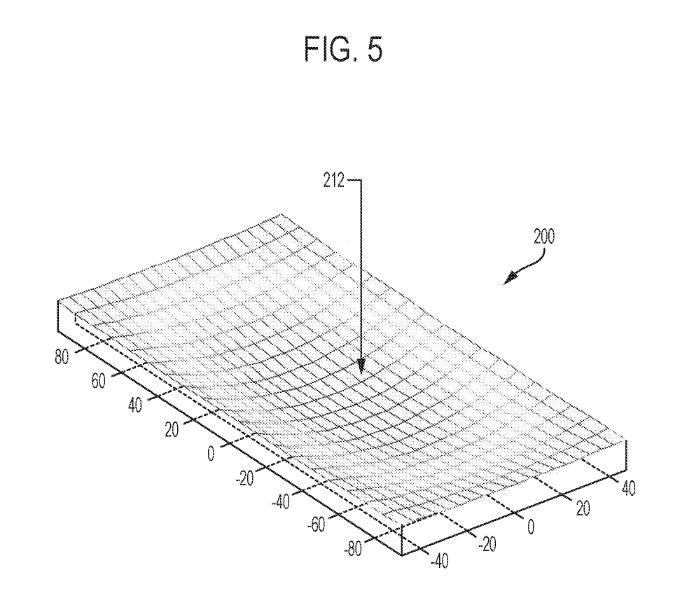

A plot of the curved shell surface from this equation is shown in FIG. 5. The concavity 212 of panel 200 is shown at the center of the panel 200. As previously explained, the plotted curved shell surface may cause a downward force to be exerted on the panel 200 toward a mounting surface.

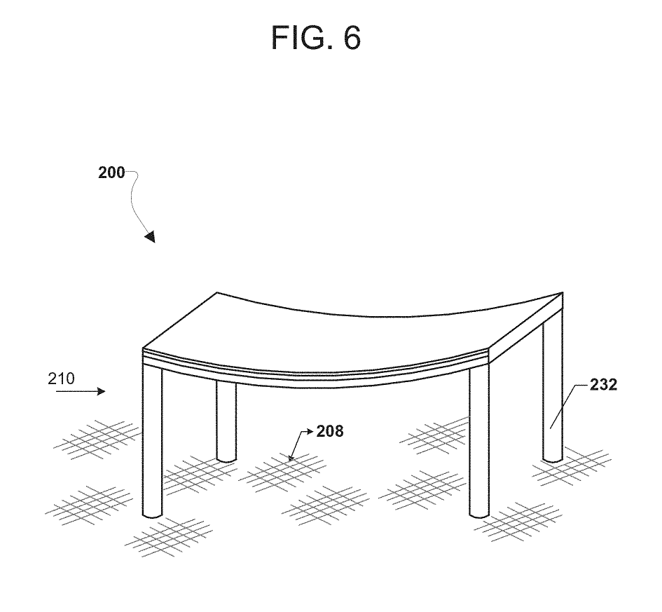

FIG. 6 is a perspective view of a flexible photovoltaic panel 200 mounted to a building structure (e.g., a roof 208) according to another embodiment. The flexible panel 200 may be formed into a curvature so that the panel 200 has a concave shape with respect to an outer top surface and a convex shape with respect to an outer bottom surface. The panel 200 may be connected to the roof 208 by four mounted support columns 232. However, there may be various other types of mounting arrangements and structures to secure the curved panel 200 to the roof 208. This mounting enables wind 210 to flow beneath the panel 200.

As previously discussed, the panel 200 may be configured so that wind direction 210 flowing parallel to the panel 200 induces a low pressure area beneath the panel 200, thereby causing a downward force to be exerted on the panel 200 toward the roof 208 in opposition to a drag force applied at a leading edge of the panel 200. The downward force may be greater than the drag force and acts perpendicular to the outer top surface, compressing the mounted support columns 232 toward the roof 208, while the drag force acts perpendicular to the outer bottom surface, at the leading edge of the panel 200, tensioning the mounted support columns 232 extending from the roof 208.

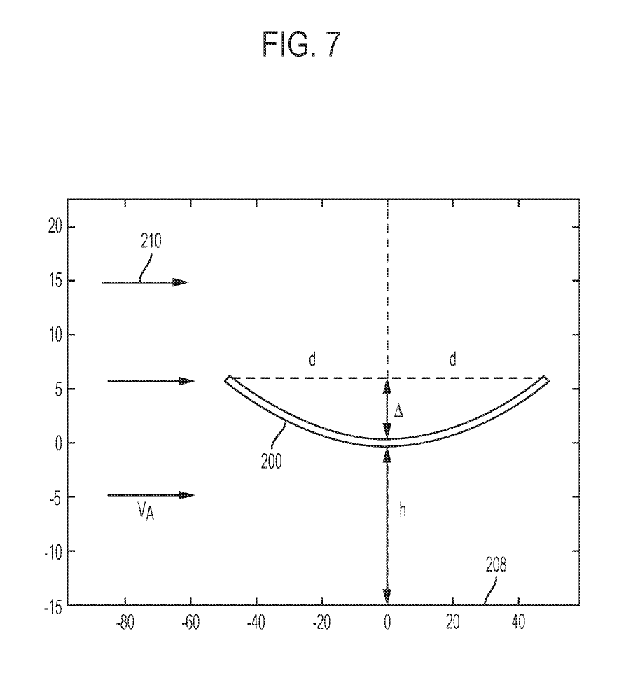

For greater clarity this section concludes with an illustration of Bernoulli's relation for a simple case where the ambient wind velocity V_{A} is in the x direction normal to one side of a panel 200 as shown in FIG. 7. Bernoulli's relation is given by:

p_{A}+1/2ρV_{A}²=p(x)+1/2ρV²(x)

where p_{A} is the ambient air pressure, ρ is the density of air, p(x) is the air pressure beneath the panel, and V(x) is the air velocity beneath the panel. The downward force on the panel is caused by the difference between the ambient pressure outside the panel and the lower pressure beneath the panel. Suppose the panel has a width 2d in the x direction and a length L, where x=0 at the center of the panel in FIG. 7. Then the downward force on the panel is:

$$F = 2 L {\int }_{- d}^{d} [ {p}_{A} - p ( x ) ] dx = L ρ {V}_{A}^{2} {\int }_{- d}^{d} dx [ \frac{{V}^{2} ( x )}{{V}_{A}^{2}} - 1 ]$$

The ratio V(x)/V_{A} is purely geometrical: if y(x) is the distance between the bottom of the panel and the roof, then V(x)/V_{A}=y(−d)/y(x): the decreasing distance between the underside of the panel and the roof causes the wind speed to increase beneath the panel. Hence the downward force on the panel may be written as:

F=AρV_{A}²G

where A=2dL is the projected area of the panel and G is a dimensionless geometrical constant independent of pressure or velocity. From this equation it can be seen that the downward force generated by the curved panel 200 is proportional to the projected area A of the panel and the square of the ambient wind velocity V_{A}.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

1. A solar panel, comprising:
a receiving layer oriented to receive sunlight;
a photovoltaic layer adjacent to the receiving layer;
a base layer adjacent to the photovoltaic layer; and
a bottom surface adjacent to the base layer having a curved shape configured to generate a downward force when subject to wind.

2. The solar panel of claim 1, wherein:
an outer surface of the receiving layer has a concave shape; and
the bottom surface is an outer surface of the base layer that has a convex shape.

3. The solar panel of claim 1, wherein:
an outer surface of the receiving layer is planar; and
the bottom surface is integral to the base layer and has a convex shape.

4. The solar panel of claim 3, wherein the bottom surface comprises a shell coupled to the base layer with an outer surface that has a convex shape.

5. The solar panel of claim 4, wherein the shell is connected to the base layer by fasteners.

6. The solar panel of claim 4, wherein the shell forms a void space between the shell and the base layer.

7. The solar panel of claim 1, wherein the bottom surface is configured to generate a downward force when subject to wind that offsets an opposing drag force generated by the wind.

8. The solar panel of claim 1, wherein a curvature of the bottom surface is symmetric about a center of the solar panel.

9. The solar panel of claim 1, wherein a curvature of the bottom surface is symmetric about a longitudinal axis and symmetric about a lateral axis of the solar panel.

10. The solar panel of claim 9, wherein the length of the longitudinal axis exceeds the width of the lateral axis of the solar panel.

11. The solar panel of claim 1, wherein the solar panel is mounted to a building structure and is configured to resist wind loads to the solar panel.

12. The solar panel of claim 4, wherein the curvature of bottom surface is given by formula:
$$z ( x , y ) = Δ [ 1 - \frac{{( x - {x}_{0} )}^{2} {( y - {y}_{0} )}^{2}}{{x}_{0}^{2} {y}_{0}^{2}} ] ,$$
in which x₀ and y₀ are half widths of the rectangular solar panel, Δ=the depth of the shell at the center of the shell, and Δ−z=the depth of the shell at a particular position.
